(19) United States
(12) Patent Application Publication
(10) Pub. No.: US 2024/0251293 A1
(43) Pub. Date: Jul. 25, 2024

(54) APPARATUS AND METHOD FOR PROVIDING INTENT-BASED NETWORK MANAGEMENT AUTOMATION IN 5G NETWORKS

(71) Applicant: Research & Business Foundation SUNGKYUNKWAN UNIVERSITY, Suwon-si (KR)

(72) Inventor: Jaehoon JEONG, Busan (KR)

(73) Assignee: Research & Business Foundation SUNGKYUNKWAN UNIVERSITY, Suwon-si (KR)

(21) Appl. No.: 18/383,124

(22) Filed: Oct. 24, 2023

(30) Foreign Application Priority Data
Oct. 24, 2022 (KR) 10-2022-0137278

(51) Int. Cl. H04W 28/08; H04W 48/16

(52) U.S. Cl. CPC H04W 28/0925; H04W 48/16

(57) ABSTRACT

The present disclosure relates to a network management automation (NMA) technology of cellular network services in 5G networks. A device for providing an intent-based network management automation in an intent-based networking (IBN) framework includes an IBN controller configured to control and manage system components including network service functions (NSFs). The IBN controller is further configured to translate a high-level network policy into a corresponding low-level network policy, select an appropriate NSF for the translated low-level network policy, and induce the selected NSF to execute network rules of the low-level network policy.

### TECHNICAL FIELD

The present disclosure relates to a network management automation (NMA) technology of cellular network services in 5G networks. More particularly, the present disclosure relates to an apparatus and method for providing an intent-based network management automation in an intent-based networking (IBN) framework, and a computer readable medium recording a program for executing it on a computer.

### BACKGROUND ART

5G networks are evolutionary mobile networks over 4G networks in terms of high speed, wide bandwidth, high frequency bands, massive device connectivity, low energy consumption, and intelligence. Especially, the intelligence will be a key feature to understand the intents of users and automate network management fully. The 5G networks are designed and implemented on the experience from 4G networks and new technologies which include Software-Defined Networking (SDN) and Network Functions Virtualization (NFV) along with mmWave for low delivery delay, high data speed, and large network capacity.

The support of network intelligence is one of the main goals of 5G networks. The network intelligence can provide the 5G networks with Network Management Automation (NMA) for a self-driving network that optimizes and adjusts itself by minimizing the interaction with humans (e.g., network administrators and users).

### SUMMARY OF INVENTION

### Technical Problem

The technical objective to be achieved by embodiments of the present disclosure is to overcome a weakness in that a detailed design and architecture capable of fully implementing the support of network intelligence that is a main goal of 5G networks are insufficient, and to solve a problem in that there is no framework capable of combining a concept of intent-based networking and monitoring and analysis for multiple network service functions (NSFs) of cellular networks with 5G networks.

The technical objectives to be achieved by the present disclosure are not limited to those that have been described hereinabove merely by way of example, and other technical objectives that are not mentioned can be clearly understood by those skilled in the art, to which the present disclosure pertains, from the following descriptions.

### Technical Solution

To solve the above-described and other technical problems, in one aspect of the present disclosure, there is provided a device for providing an intent-based network management automation in an intent-based networking (IBN) framework comprising an IBN controller configured to control and manage system components including network service functions (NSFs), wherein the IBN controller is further configured to translate a high-level network policy into a corresponding low-level network policy, select an appropriate NSF for the translated low-level network policy, and induce the selected NSF to execute network rules of the low-level network policy.

The IBN controller may be further configured to translate an intent expressed in a natural language input from a network operator or a user into the high-level network policy through a natural language processing (NLP) technique and receive it via a consumer-facing interface.

The IBN controller may be further configured to remotely configure a network policy to the appropriate NSF using the low-level network policy via an NSF-facing interface, in order to enforce a commanded intent in a target network.

The NSFs may be at least one of a virtual network function (VNF), a physical network function (PNF), or a container network function (CNF).

The IBN controller may be further configured to receive a registration of an NSF's capability and access information from a vendor's management system (VMS) via a registration interface, or transmit and receive an NSF query to and from the vendor's management system for an NSF search, which will service the required low-level network policy, via the registration interface.

The IBN controller may be further configured to receive a report of the network rules via an analytics interface from an IBN analyzer that analyzes monitoring data for the NSFs and checks activity and performance of the NSFs using a machine learning technique.

If a suspicious problem for a target network or the NSFs is detected based on the monitoring data collected via a monitoring interface, the IBN controller may be further configured to receive a report of augmentation or generation of the network rules from the IBN analyzer and apply the report to a network policy management.

The IBN controller may be a network data analytics function (NWDAF) in 5G networks.

To solve the above-described and other technical problems, in another aspect of the present disclosure, there is provided a method of providing an intent-based network management automation in an intent-based networking (IBN) framework, the method performed by an IBN controller comprising steps of (a) receiving a high-level network policy; (b) translating the high-level network policy into a corresponding low-level network policy; and (c) selecting an appropriate network service function (NSF) for the translated low-level network policy and inducing the selected NSF to execute network rules of the low-level network policy.

The step (a) of receiving the high-level network policy may comprise translating an intent expressed in a natural language input from a network operator or a user into the high-level network policy through a natural language processing (NLP) technique and receiving it via a consumer-facing interface.

The step (b) of translating the high-level network policy into the corresponding low-level network policy may comprise steps of (b1) using a translator to extract policy-related attribute data from the high-level network policy; (b2) using the translator to convert the attribute data into attribute data of a corresponding low-level policy based on mapping information between attributes of the high-level network policy and attributes of the low-level network policy; and (b3) using the translator to generate the low-level network policy based on the converted attribute data of the low-level policy.

The step (b) of translating the high-level network policy into the corresponding low-level network policy may further comprise a step of (b4) using the translator to identify an NSF for a requested network policy. If the identified NSF for the requested network policy is available, the method may proceed to the step of generating the low-level network policy.

The step (b) of translating the high-level network policy into the corresponding low-level network policy may further comprise (b4) using the translator to identify an NSF for a requested network policy; and (b5) if the identified NSF for the requested network policy is unavailable, searching for an appropriate NSF for the requested network policy.

The step (b5) of searching for the appropriate NSF for the requested network policy may comprise sending an NSF query request to a vendor's management system (VMS) via a registration interface so as to find the appropriate NSF for the requested network policy; and receiving, from the vendor's management system, an NSF query response that tells the NSF its readiness to perform a task along with network access information for the NSF.

The step (c) of selecting the appropriate NSF for the translated low-level network policy and inducing the selected NSF to execute the network rules of the low-level network policy may comprise, based on network access information for an NSF, sending a low-level network policy request to the appropriate NSF for the translated low-level network policy via an NSF-facing interface to allow the NSF to remotely perform a configuration for the given low-level network policy request for performing the requested task.

The method may further comprise a step of (d) receiving a report of the network rules from an IBN analyzer via an analytics interface.

The step (d) of receiving the report of the network rules may comprise receiving, from the IBN analyzer, a report generated based on a result of checking activity and performance of the NSF using a machine learning technique while analyzing monitoring data for the NSF collected from at least one NSF via a monitoring interface between the NSF and the IBN analyzer.

The step (d) of receiving the report of the network rules may comprise, if a suspicious problem for a target network or the NSF is detected based on the monitoring data, receiving a report of augmentation or generation of the network rules from the IBN analyzer and applying the report to a network policy management.

The step (d) of receiving the report of the network rules may comprise, if the suspicious network problem is detected, sending an updated policy request or a new policy request based on the report to the appropriate NSF to induce the appropriate NSF to perform a reconfiguration or a configuration.

The following provides a computer readable medium recording a program for executing the above-described method of providing the intent-based network management automation on a computer.

### Effects of the Invention

Embodiments of the present disclosure can provide an architectural framework combining a concept of intent-based networking (IBN) and monitoring and analysis for multiple network service functions (NSFs) of cellular networks with 5G networks, as an IBN controller controlling and managing system components in an intent-based networking framework receives a report of network rules from an IBN analyzer that analyzes monitoring data for NSFs and checks activity and performance of the NSFs using a machine learning technology.

Effects that could be achieved with the present disclosure are not limited to those that have been described hereinabove merely by way of example, and other effects and advantages of the present disclosure will be more clearly understood from the following description by a person skilled in the art to which the present disclosure pertains.

### BRIEF DESCRIPTION OF THE DRAWINGS

The accompanying drawings, which are included to provide a further understanding of the present disclosure and constitute a part of the detailed description, illustrate embodiments of the present disclosure and serve to explain technical features of the present disclosure together with the description.

FIG. 1 is a block diagram illustrating a device providing intent-based network management automation in an intent-based networking (IBN) framework for 5G networks according to an embodiment of the present disclosure.

FIG. 2 is a block diagram illustrating activity auditing using a network audit system of an IBN framework according to an embodiment of the present disclosure.

FIG. 3 illustrates a procedure of enforcing an IoT device data aggregation policy in an IBN framework.

FIG. 4 illustrates a procedure of the reporting for IoT device data aggregation in an IBN framework.

FIG. 5 is a flowchart illustrating a method of providing intent-based network management automation in an IBN framework for 5G networks according to another embodiment of the present disclosure.

### DETAILED DESCRIPTION

Reference will now be made in detail to embodiments of the disclosure, examples of which are illustrated in the accompanying drawings. Detailed descriptions of known arts will be omitted if such may mislead the gist of the present disclosure. In addition, throughout the present disclosure, “comprising” a certain component means that other components may be further comprised, not that other components are excluded, unless otherwise stated.

Terms used in the present disclosure are only used to describe specific embodiments, and are not intended to limit the present disclosure. Expressions in the singular form include the meaning of the plural form unless they clearly mean otherwise in the context. In the present disclosure, expressions such as “comprise” or “have” are intended to mean that the described features, numbers, steps, operations, components, parts, or combinations thereof exist, and should not be understood to be intended to exclude in advance the presence or possibility of addition of one or more other features, numbers, steps, operations, components, parts, or combinations thereof.

Unless otherwise specified, all of the terms which are used herein, including the technical or scientific terms, have the same meanings as those that are generally understood by a person having ordinary skill in the art to which the present disclosure pertains. The terms defined in a generally used dictionary can be understood to have meanings identical to those used in the context of a related art, and are not to be construed to have ideal or excessively formal meanings unless they are obviously specified in the present disclosure.

Intent-based networking (IBN) is a feasible approach that can provide 5G networks with network management automation (NMA) services. The concept of IBN enables a closed-loop network control architecture that can adapt to a current status of a target network by collecting and analyzing monitoring data from network service functions (NSFs). The NSFs may be at least one of a virtual network function (VNF), a physical network function (PNF), or a container network function (CNF) in cloud and edge computing environments. In the 3rd Generation Partnership Project (3GPP), a network data analytics function (NWDAF) is defined to collect and analyze monitoring data from multiple VNFs, PNFs, and CNFs in cellular networks.

For the intelligent NMA services, the present disclosure proposes an architectural framework that combines the IBN and the NWDAF with the 5G networks through artificial intelligence (AI) and machine learning (ML). The proposed framework can allow an intent of a network operator or user to be translated into a high-level policy through a natural language processing (NLP) technique such as Lumi. Then, the high-level policy is translated into a low-level policy through policy data model mapping and a network policy translator (NPT). The low-level policy is used to remotely configure the network policy to appropriate VNFs, PNFs, or CNFs in order to enforce the commanded intent in a target network (e.g., 5G networks). Further, it also collects and analyzes the monitoring data from the VNFs, PNFs, or CNFs such that the network policy can be verified and optimized to satisfy the requests for the intent.

Therefore, the NMA in the present disclosure deals with closed-loop network control, network policy translation, and network management audit. To support the three features in the NMA, it specifies an architectural framework with system components and interfaces. In addition, this framework can support use cases of NMA in 5G networks such as the data aggregation of Internet of Things (IOT) devices, network slicing, and the Quality of Service (QoS) in Vehicle-to-Everything (V2X). Especially, the present disclosure shows a use case of IoT in 5G networks such as the data collection and analysis of IoT devices.

The terminology used in the present disclosure is defined as follows.

### Network Management Automation (NMA)

Network management automation means that a high-level network policy from a user (or administrator) is well-enforced to a target network system. The high-level network policy can be translated into a corresponding low-level network policy by a network policy translator and dispatched to appropriate NSFs. The activity and performance of the NSFs are monitored and analyzed through the monitoring of the NSFs. If necessary or desired, network rules of the low-level network policy are augmented or new network rules are generated, and they are configured to the appropriate NSFs.

### Network Policy Translation (NPT)

Network policy translation means that a high-level network policy is translated into a low-level network policy that can be understood and configured by an NSF for a specific network service, such as data aggregation of IoT devices, network slicing, and the QoS provisioning in V2X communications.

### Feedback-Based Network Management (FNM)

Feedback-based network management means that a network service is evolved by updating a network policy (including network rules) and adding new network rules for detected network problems by processing and analyzing the monitoring data of NSFs.

An IBN framework for 5G networks is described below.

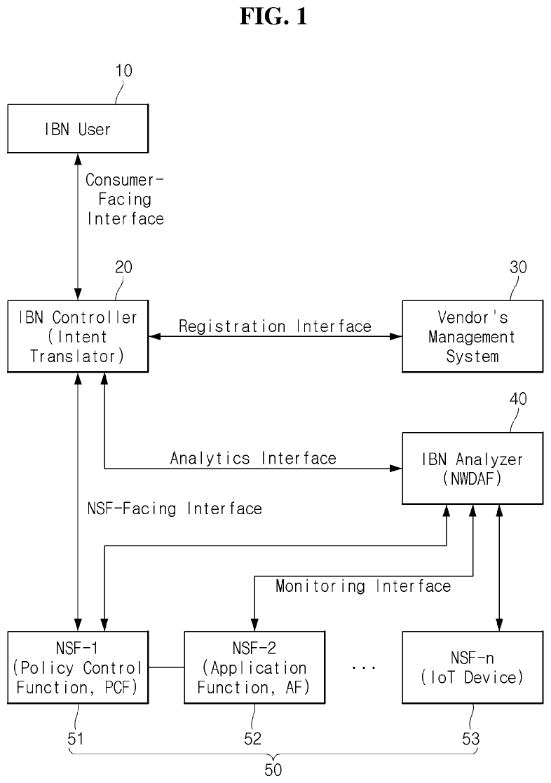

FIG. 1 is a block diagram illustrating a device providing intent-based network management automation in an intent-based networking (IBN) framework for 5G networks according to an embodiment of the present disclosure.

The IBN Framework is based on a framework for Interface to Network Security Functions (I2NSF). An object of the I2NSF is to define standardized interfaces for heterogeneous network service functions (NSFs) provided by multiple security solution vendors. In architecture of the I2NSF, without considering in detail the management of NSF (the management of NSF ultimately requires the enforcement of security policy), a user can define a policy for managing and protecting network resources within a network system of the user. In addition, the standardized interfaces to the NSF from multiple vendors can simplify configuration and management of a task for heterogeneous NSFs.

As illustrated in FIG. 1, an IBN user can use network functions by delivering a high-level network policy, which specifies network requirements that the IBN user wants to enforce, to an IBN controller via a consumer-facing interface (CFI). The following are system components for the IBN framework for network management automation in 5G networks.

### IBN User

An IBN user 10 is an entity delivering a high-level network policy to an IBN controller 20. In this instance, intent of a natural language (e.g., English) can be translated into the high-level network policy through a natural language processing (called NLP) technique (e.g., Lumi). The IBN user 10 needs to use network service functions that protect network traffic from various malicious security attacks or perform specific network services (e.g., data aggregation from IoT devices). To request the configuration of the network service functions, the IBN user 10 can generate the high-level network policy for the network service, that the IBN user wants, and deliver it to the IBN controller 20.

### IBN Controller

The IBN controller 20 is an entity that controls and manages other system components in the IBN framework. The IBN controller 20 translates the high-level network policy into a corresponding low-level network policy and selects appropriate NSFs to execute network rules of the low-level network policy. To this end, the IBN controller 20 may include an intent translator. Ultimately, the IBN controller 20 may configure the generated low-level network policy to each NSF. In addition, the IBN controller 20 may monitor the NSFs running in the system and maintain a variety of information (e.g., network access information and workload status, etc.) on each NSF.

### Vendor's Management System (VMS)

A vendor's management system 30 is an entity that provides an image of a virtualized NSF for a network service to the IBN framework and registers the capability and access information of the NSF with the IBN controller 20.

### Network Service Function (NSF)

Each of NSFs (50: 51, 52, 53) is a logical entity or a software component that provides network services. For example, the NSFs may receive the low-level network policy, detect malicious network traffic based on it, and block or mitigate it. Through this, integrity and confidentiality of a network communication stream can be guaranteed.

Each of the NSFs (50: 51, 52, 53) is an entity corresponding to at least one of a virtual network function (VNF), a physical network function (PNF), or a container network function (CNF) which is also called cloud-native network function, for a specific network service such as the data aggregation of IoT devices, network slicing, and the QoS provisioning in V2X communications.

### IBN Analyzer

An IBN analyzer 40 is an entity that collects monitoring data from the NSFs (50: 51, 52, 53) and analyzes such data to check the activity and performance of the NSF using machine learning techniques (e.g., deep learning, decision tree, random forest, etc.). The IBN analyzer 40 may be a network data analytics function (NWDAF) in 5G networks. If there is a suspicious problem (e.g., security attacks, overload, lack of hardware resources, traffic congestion, or QoS degradation) for a target network or the NSF, the IBN analyzer 40 delivers a report of the augmentation or generation of network rules to the IBN controller 20.

For IBN-based network services in which feedback-based network management (FNM) is implemented, the IBN analyzer 40 is a key IBN component for the IBN framework that collects monitoring data from the NSF and analyzes the monitoring data.

It can be seen from FIG. 1 that various interfaces for the IBN framework are illustrated together. The interfaces may be modeled using YANG Data Modeling Language [RFC6020] or YAML Data Serialization Language [YAML], and the network policies are delivered through either RESTCONF [RFC8040] or NETCONF [RFC6241]. In addition, according to 3GPP specifications, REST API [REST] may be supported for those interfaces.

### Consumer-Facing Interface

A consumer-facing interface is an interface between the IBN user 10 and the IBN controller 20 for the delivery of the high-level network policy. By designing the interface in this way, it conceals the detailed contents of the underlying NSF and provides only the abstract view of the NSF to the user.

### NSF-Facing Interface

An NSF-facing interface is an interface between the IBN controller 20 and the NSFs (50: 51, 52, 53) for the delivery of the low-level network policy. The IBN controller 20 in the IBN framework does not need to use all capabilities of the given NSF, nor does it need to use all the available NSFs. Thus, this abstraction allows NSF features to be treated as building blocks by the NSF system. Therefore, developers are free to use network capabilities defined by the vendor and NSF that is independent to technology.

### Registration Interface

A registration interface is an interface between the vendor's management system 30 and the IBN controller 20 for the registration of an NSF's capability and access information with the IBN controller 20 or the query of an NSF for the required low-level network policy. The NSFs (50: 51, 52, 53) provided by different vendors may have a different capability. Therefore, in order to automate the process of using different types of network capabilities provided by the different vendors, it is necessary for the vendors to have a dedicated interface for defining the capabilities of their NSFs, and the dedicated interface is called registration interface.

The NSF's capabilities can be pre-configured or dynamically retrieved through the registration interface. If new functions exposed to the user are added to the NSF, capabilities of the new functions needs to be registered in a registry of the IBN controller 20 via the registration interface so that the interested management and control entities can be made aware of them.

### Monitoring Interface

A monitoring interface is an interface between the NSFs (50: 51, 52, 53) and the IBN analyzer 40 for collecting monitoring data from the NSFs (50: 51, 52, 53) to check the activity and performance of an NSF for a possible network problem.

### Analytics Interface

An analytics interface is an interface between the IBN analyzer 40 and the IBN controller 20 for the delivery of an analytics report of the augmentation or generation of network rules to the IBN controller 20. Through this, the IBN controller 20 can apply the report of network rules to its network policy management.

For IBN-based network services, the analytics interface is a key interface in the IBN framework to deliver an analytics report of the augmentation or generation of network rules to the IBN controller 20 through the analysis of the monitoring data from the NSFs (50: 51, 52, 53).

In summary, a device providing intent-based network management automation according to an embodiment of the present disclosure includes the IBN controller 20 that controls and manages system components including network service functions (NSFs) in the intent-based networking framework. The IBN controller 20 translates a high-level network policy into a corresponding low-level network policy, selects an appropriate NSF for the translated low-level network policy, and induces the selected NSF to execute network rules of the low-level network policy.

The IBN controller 20 can translate an intent expressed in a natural language input from the network operator or the IBN user 10 into the high-level network policy through the natural language processing (NLP) technique and receive it via the consumer-facing interface.

The IBN controller 20 can remotely configure the network policy to the appropriate NSF using the low-level network policy via the NSF-facing interface, in order to enforce the commanded intent in the target network.

In addition, the IBN controller 20 can receive the registration of an NSF's capability and access information from the vendor's management system 30 via the registration interface. Alternatively, the IBN controller 20 can transmit and receive the NSF query to and from the vendor's management system 30 for an NSF search, which will service the required low-level network policy, via the registration interface.

Furthermore, the IBN controller 20 can receive a report of the network rules via the analytics interface from the IBN analyzer 40 that analyzes monitoring data for the NSFs (50: 51, 52, 53) and checks the activity and performance of the NSFs using the machine learning technique.

In this instance, if a suspicious problem (e.g., security attacks, overload, lack of hardware resources, traffic congestion, or QoS degradation) for a target network or the NSF is detected based on the monitoring data collected via the monitoring interface, the IBN controller 20 can receive a report of the augmentation or generation of network rules from the IBN analyzer 40 and apply the report to the network policy management.

The IBN framework is weak to both an insider attack and a supply chain attack since it trusts in NSFs provided by VMS and assumes that NSFs work for their network services appropriately.

To detect the malicious activity of either an insider attack by a malicious VMS or a supply chain attack by a compromised VMS, a network audit system is required by the IBN framework. This network audit system can facilitate the non-repudiation of configuration commands and monitoring data generated in the IBN framework.

The network audit system has the following four main objectives:
to check the existence of a network policy, a management system, and its procedures;
to identify and understand the existing vulnerabilities and risks of either an insider attack or a supply chain attack;
to review existing network controls on operational and administrative issues; and
to provide recommendations and corrective actions to the IBN controller for further network and security improvement.

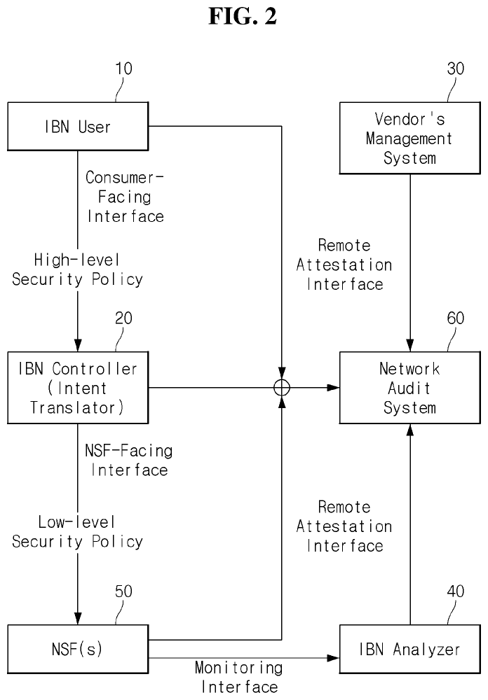

FIG. 2 is a block diagram illustrating activity auditing using a network audit system of an IBN framework according to an embodiment of the present disclosure.

All the components in the IBN framework report its activities (e.g., configuration commands and monitoring data) to a network audit system 60 as transactions through a remote attestation interface. The network audit system 60 can analyze the reported activities from the IBN components to detect malicious activities such as an insider attack and a supply chain attack. The network audit system 60 can be implemented by remote attestation or blockchain. Since the details of the implementation of the network audit system are out of the scope of the present disclosure, the detailed description is omitted here.

In order to determine a minimum set of controls required to reduce the risks from either an insider attack or a supply chain attack, the network audit system 60 should periodically analyze the activities of all the components in the IBN framework, evaluate possible risks, and take an action to such risks since vulnerabilities and threats may change in various environments over time.

The following describes a use case where a policy of IoT device data aggregation is set up in the IBN framework for 5G networks.

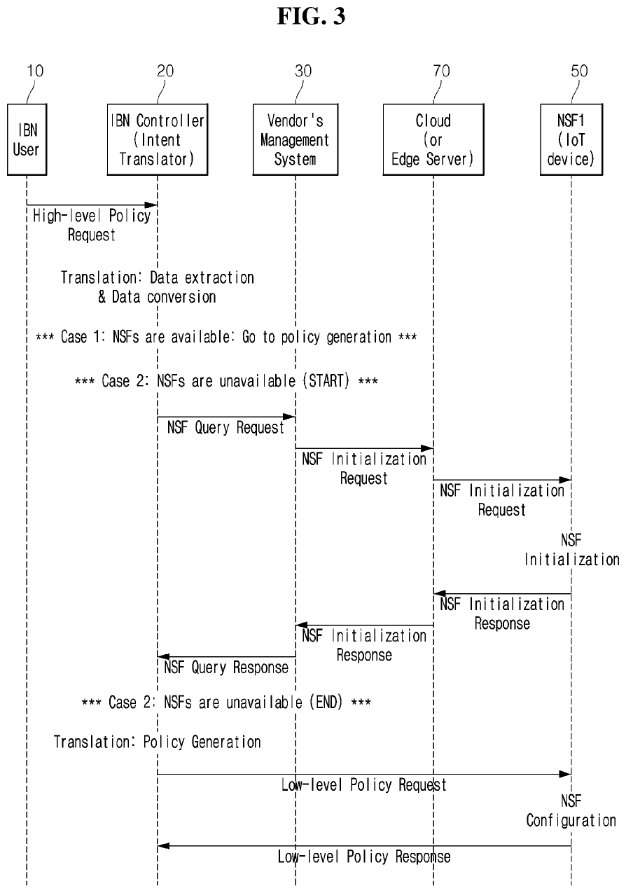

FIG. 3 illustrates a procedure of enforcing an IoT device data aggregation policy in an IBN framework. Each step is described in detail as follows:
1. The IBN user 10 sends a high-level policy request to the IBN controller 20.
2. The IBN controller 20 translates the request using a network policy translator (called NPT). The NPT identifies NSFs (i.e., IoT devices) for the request after the steps of policy data extraction and policy data conversion.
3. If the NSFs are available for the requested network policy, go to the step of policy generation in the NPT. On the other hand, if the NSFs are unavailable for the requested network policy, go to the next step.
4. The IBN controller 20 sends an NSF query request to the vendor's management system 30 (called VMS) to find an appropriate NSF for the requested network policy.
5. If there is such an NSF registered with the VMS, the vendor's management system 30 sends an NSF initialization request to a cloud (or edge server) 70 to initialize the NSF.
6. The cloud (or edge server) 70 forwards the NSF initialization request to an appropriate NSF 50 to let it initialize itself.
7. The NSF 50 performs an initialization to perform a task for a network policy in 5G networks.
8. The NSF 50 sends an NSF initialization response to the cloud (or edge server) 70 to tell the cloud (or edge server) 70 its readiness to perform a task.
9. The cloud (or edge server) 70 forwards the NSF initialization response to the vendor's management system 30 to tell the NSF 50 its readiness to perform a task.
10. The vendor's management system 30 sends an NSF query response to the IBN controller 20 to tell the NSF 50 its readiness to perform a task along with the network access information for the NSF.
11. The IBN controller 20 performs the step of policy generation in its NPT along with the network access information of the appropriate NSF.
12. The IBN controller 20 sends a low-level policy request to the appropriate NSF 50.
13. The NSF 50 performs the configuration in the given low-level policy request to perform the requested task (e.g., sensing and reporting).
14. The NSF 50 sends a low-level policy response to the IBN controller 20 to tell its readiness to perform the requested task.

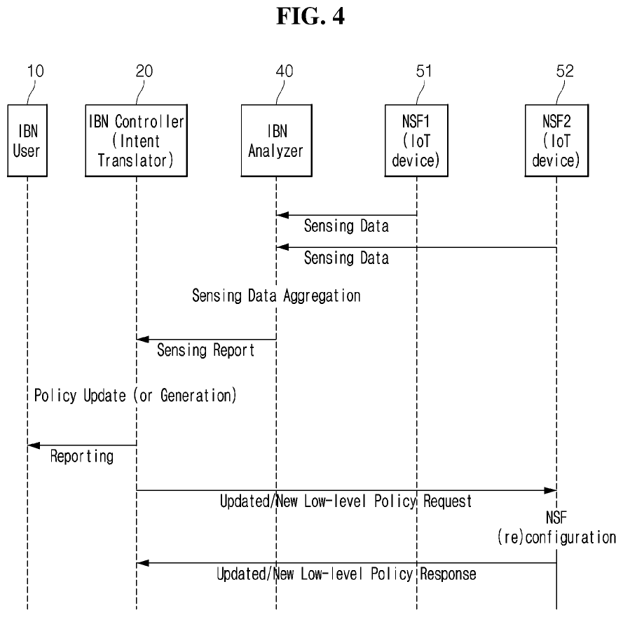

FIG. 4 illustrates a procedure of the reporting for IoT device data aggregation in an IBN framework. Each step is described in detail as follows:
1. NSF1 51 (as an IoT device) sends its sensing data to the IBN analyzer 40 (as an NWDAF).
2. NSF2 52 (as an IoT device) sends its sensing data to the IBN analyzer 40 (as an NWDAF).
3. The IBN analyzer 40 performs sensing data aggregation and analyzes the aggregated sensing data through machine learning (ML) techniques. The IBN analyzer 40 then generates a sensing report for the IBN controller 20.
4. The IBN analyzer 40 sends the sensing report to the IBN controller 20.
5. The IBN controller 20 analyzes the sensing report for a further action. If the further action is needed, the IBN controller 20 updates the existing network policy or generates a new network policy.
6. If the reporting is needed, the IBN controller 20 optionally sends the report for the further action to the IBN user 10.
7. For the further action, the IBN controller 20 sends an updated NSF policy request or a new NSF policy request to the appropriate NSF 52.
8. The appropriate NSF 52 reconfigures the updated NSF policy or configures the new NSF policy in its own system.
9. The appropriate NSF 52 sends an updated NSF policy response or a new NSF policy response to the IBN controller 20.

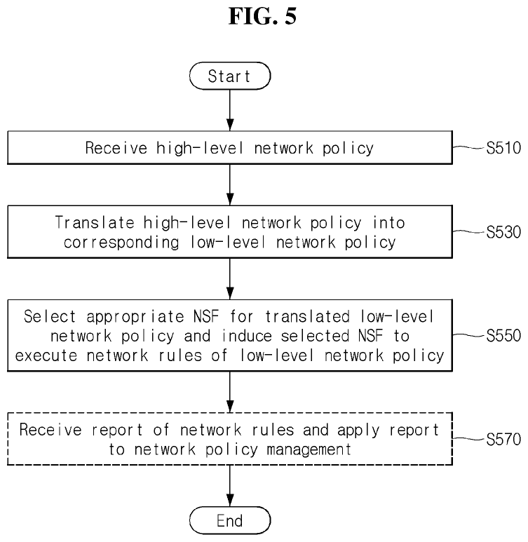

FIG. 5 is a flowchart illustrating a method of providing intent-based network management automation in an IBN framework for 5G networks according to another embodiment of the present disclosure. More specifically, FIG. 5 illustrates reconfiguration of each component or function of the IBN framework of FIG. 1 described in terms of hardware configuration based on a time-series flow. Therefore, the performance of each step will be outlined to avoid the duplication of explanation.

In step S510, an IBN controller receives a high-level network policy. In this process, the IBN controller may translate an intent expressed in a natural language input from a network operator or an IBN user into the high-level network policy through a natural language processing (NLP) technique and receive it via a consumer-facing interface.

In step S530, the IBN controller translates the high-level network policy into a corresponding low-level network policy. First, the IBN controller may use a translator to extract policy-related attribute data from the high-level network policy. Then, the IBN controller may use the translator to convert the attribute data into attribute data of a corresponding low-level policy based on mapping information between attributes of the high-level network policy and attributes of the low-level network policy. The IBN controller may use the translator to generate the low-level network policy based on the converted attribute data of the low-level policy.

In addition, the step S530 may further comprise a process of identifying network service functions (NSFs) for a requested network policy using the translator. In this instance, if the identified NSFs for the requested network policy are available, the method may proceed to the step of generating the low-level network policy. On the other hand, if the identified NSFs for the requested network policy are unavailable, the method may further perform a step of searching for an appropriate NSF for the requested network policy. More specifically, the step of searching for the appropriate NSF for the requested network policy may comprise sending an NSF query request to a vendor's management system (VMS) via a registration interface to find the appropriate NSF for the requested network policy, and receiving, from the vendor's management system, an NSF query response that tells the NSF its readiness to perform a task along with network access information for the NSF.

In step S550, the IBN controller selects the appropriate NSF for the low-level network policy translated through the step S530 and induces the selected NSF to execute network rules of the low-level network policy. In this process, based on the network access information for the NSF, the IBN controller may send a low-level network policy request to the appropriate NSF for the translated low-level network policy via an NSF-facing interface to allow the NSF to remotely perform a configuration for the given low-level network policy request for performing the requested task.

In step S570, the IBN controller may receive a report of the network rules from an IBN analyzer via an analytics interface. This process may be selectively performed in a situation where monitoring for the NSF is required.

More specifically, in this process, the IBN controller may receive, from the IBN analyzer, a report generated based on a result of checking activity and performance of the NSF using a machine learning technique while analyzing monitoring data for the NSF collected from at least one NSF via a monitoring interface between the NSF and the IBN analyzer.

In addition, in the step S570, if a suspicious problem (e.g., security attacks, overload, lack of hardware resources, traffic congestion, or QoS degradation) for a target network or the NSF is detected based on the monitoring data, the IBN controller may receive a report of the augmentation or generation of the network rules from the IBN analyzer and apply the report to the network policy management. In particular, if the suspicious network problem is detected, the IBN controller may send an updated policy request or a new policy request based on the report to the appropriate NSF to induce the appropriate NSF to perform a reconfiguration or a configuration.

So far, the present disclosure has described the network management automation (NMA) of cellular network services in 5G networks. For the NMA, embodiments of the present disclosure have proposed a framework empowered with intent-based networking (IBN). The NMA in the present disclosure deals with closed-loop network control, network policy translation, and network management audit. To support the three features in the NMA, embodiments of the present disclosure have specified an architectural framework with system components and interfaces. In addition, this framework can support use cases of NMA in 5G networks such as the data aggregation of IoT devices, network slicing, and the QoS in V2X.

As described above, embodiments of the present disclosure can provide an architectural framework combining a concept of intent-based networking and monitoring and analysis for multiple NSFs of cellular networks with 5G networks, as an IBN controller controlling and managing system components in an intent-based networking framework receives a report of network rules from an IBN analyzer that analyzes monitoring data for NSFs and checks activity and performance of the NSFs using a machine learning technology.

Embodiments of the present disclosure can be implemented by various means, for example, hardware, firmware, software, or combinations thereof. When embodiments are implemented by hardware, one embodiment of the present disclosure can be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and the like. When embodiments are implemented by firmware or software, one embodiment of the present disclosure can be implemented by modules, procedures, functions, etc. performing functions or operations described above. Software code can be stored in a memory and can be driven by a processor. The memory is provided inside or outside the processor and can exchange data with the processor by various well-known means.

Embodiments of the present disclosure can be implemented as computer-readable codes on a computer-readable recording medium. The computer-readable recording medium includes all types of recording devices in which data readable by a computer system is stored. Examples of the computer-readable recording medium include a ROM, a RAM, a CD-ROM, a magnetic tape, a floppy disk, an optical data storage device, etc. Further, the computer-readable recording medium may be distributed to computer systems connected over a network, and computer-readable codes may be stored and executed in a distributed manner. Functional programs, codes, and code segments for implementing embodiments of the present disclosure can be easily construed by programmers skilled in the art to which the present disclosure pertains.

Accordingly, in one or more non-transitory computer readable mediums storing one or more instructions, the one or more instructions executable by one or more processors are configured to allow, in an intent-based networking (IBN) framework, an IBN controller to perform an operation of providing an intent-based network management automation, and the IBN controller is configured to receive a high-level network policy, translate the high-level network policy into a corresponding low-level network policy, and select an appropriate network service function (NSF) for the translated low-level network policy and inducing the selected NSF to execute network rules of the low-level network policy.

As described above, the present disclosure has been examined focusing on its various embodiments. A person with ordinary skills in the technical field to which the present disclosure pertains will be able to understand that the various embodiments can be implemented in modified forms within the scope of the essential characteristics of the present disclosure. Therefore, the disclosed embodiments are to be considered illustrative rather than restrictive. The scope of the present disclosure is shown in the claims rather than the foregoing description, and all differences within the scope should be construed as being included in the present disclosure.

### DESCRIPTION OF SYMBOLS

10: IBN User
20: IBN Controller (Intent Translator)
30: Vendor's Management System
40: IBN Analyzer
50, 51, 52, 53: NSF
60: Network Audit System
70: Cloud (or Edge Server)

1. A device for providing an intent-based network management automation in an intent-based networking (IBN) framework, the device comprising:
an IBN controller configured to control and manage system components including network service functions (NSFs),
wherein the IBN controller is further configured to translate a high-level network policy into a corresponding low-level network policy, select an appropriate NSF for the translated low-level network policy, and induce the selected NSF to execute network rules of the low-level network policy.

2. The device of claim 1, wherein the IBN controller is further configured to translate an intent expressed in a natural language input from a network operator or a user into the high-level network policy through a natural language processing (NLP) technique and receive it via a consumer-facing interface.

3. The device of claim 1, wherein the IBN controller is further configured to remotely configure a network policy to the appropriate NSF using the low-level network policy via an NSF-facing interface, in order to enforce a commanded intent in a target network.

4. The device of claim 1, wherein the NSFs are at least one of a virtual network function (VNF), a physical network function (PNF), or a container network function (CNF).

5. The device of claim 1, wherein the IBN controller is further configured to:
receive a registration of an NSF's capability and access information from a vendor's management system (VMS) via a registration interface, or
transmit and receive an NSF query to and from the vendor's management system for an NSF search, which will service the required low-level network policy, via the registration interface.

6. The device of claim 1, wherein the IBN controller is further configured to receive a report of the network rules via an analytics interface from an IBN analyzer that analyzes monitoring data for the NSFs and checks activity and performance of the NSFs using a machine learning technique.

7. The device of claim 6, wherein if a suspicious problem for a target network or the NSFs is detected based on the monitoring data collected via a monitoring interface, the IBN controller is further configured to receive a report of augmentation or generation of the network rules from the IBN analyzer and apply the report to a network policy management.

8. The device of claim 6, wherein the IBN controller is a network data analytics function (NWDAF) in 5G networks.

9. A method of providing an intent-based network management automation in an intent-based networking (IBN) framework, the method performed by an IBN controller comprising steps of:
(a) receiving a high-level network policy;
(b) translating the high-level network policy into a corresponding low-level network policy; and
(c) selecting an appropriate network service function (NSF) for the translated low-level network policy and inducing the selected NSF to execute network rules of the low-level network policy.

10. The method of claim 9, wherein the step (a) comprises:
translating an intent expressed in a natural language input from a network operator or a user into the high-level network policy through a natural language processing (NLP) technique and receiving it via a consumer-facing interface.

11. The method of claim 9, wherein the step (b) comprises steps of:
(b1) using a translator to extract policy-related attribute data from the high-level network policy;
(b2) using the translator to convert the attribute data into attribute data of a corresponding low-level policy based on mapping information between attributes of the high-level network policy and attributes of the low-level network policy; and
(b3) using the translator to generate the low-level network policy based on the converted attribute data of the low-level policy.

12. The method of claim 11, wherein the step (b) further comprises a step of:
(b4) using the translator to identify an NSF for a requested network policy,
wherein if the identified NSF for the requested network policy is available, the method proceeds to the step of generating the low-level network policy.

13. The method of claim 11, wherein the step (b) further comprises steps of:
(b4) using the translator to identify an NSF for a requested network policy; and
(b5) if the identified NSF for the requested network policy is unavailable, searching for an appropriate NSF for the requested network policy.

14. The method of claim 13, wherein the step (b5) comprises:
sending an NSF query request to a vendor's management system (VMS) via a registration interface so as to find the appropriate NSF for the requested network policy; and
receiving, from the vendor's management system, an NSF query response that tells the NSF its readiness to perform a task along with network access information for the NSF.

15. The method of claim 9, wherein the step (c) comprises:
based on network access information for an NSF, sending a low-level network policy request to the appropriate NSF for the translated low-level network policy via an NSF-facing interface to allow the NSF to remotely perform a configuration for the given low-level network policy request for performing the requested task.

16. The method of claim 9, further comprising a step of:
(d) receiving a report of the network rules from an IBN analyzer via an analytics interface.

17. The method of claim 16, wherein the step (d) comprises:
receiving, from the IBN analyzer, a report generated based on a result of checking activity and performance of the NSF using a machine learning technique while analyzing monitoring data for the NSF collected from at least one NSF via a monitoring interface between the NSF and the IBN analyzer.

18. The method of claim 17, wherein the step (d) comprises:
if a suspicious problem for a target network or the NSF is detected based on the monitoring data, receiving a report of augmentation or generation of the network rules from the IBN analyzer and applying the report to a network policy management.

19. The method of claim 18, wherein the step (d) comprises:
if the suspicious network problem is detected, sending an updated policy request or a new policy request based on the report to the appropriate NSF to induce the appropriate NSF to perform a reconfiguration or a configuration.

20. One or more non-transitory computer readable mediums storing one or more instructions,
wherein the one or more instructions executable by one or more processors are configured to allow, in an intent-based networking (IBN) framework, an IBN controller to perform an operation of providing an intent-based network management automation,
wherein the IBN controller is configured to:
receive a high-level network policy;
translate the high-level network policy into a corresponding low-level network policy; and
select an appropriate network service function (NSF) for the translated low-level network policy and inducing the selected NSF to execute network rules of the low-level network policy.
